(19) United States
(12) Patent Application Publication
(10) Pub. No.: US 2003/0012363 A1
(43) Pub. Date: Jan. 16, 2003

(54) Jack module with integrated modem interface circuits

(76) Inventors: Frederick F. Loeb, Scitutate, MA (US); David E. Babicz, Medway, MA (US)

Correspondence Address: Iandiorio & Teska, 260 Bear Hill Road, Waltham, MA, 02451-1018, US

(21) Appl. No.: 09/905,399

(22) Filed: Jul. 16, 2001

(51) Int. Cl. H04M 1/00; H04M 9/00

(52) U.S. Cl. 379/399.01

(57) ABSTRACT

A jack module with integrated modem interface circuits including a jack housing for receiving a plug; a plurality of contacts in the housing for engaging contacts on a plug; a plurality of terminals on the housing for interconnecting with a mounting member and a line side circuit in the jack housing and interconnecting with the contacts.

### FIELD OF INVENTION

This invention relates to a jack module with integrated modem interface circuits.

### BACKGROUND OF INVENTION

Historically modems and other devices are connected to telephone networks through an RJ11 plug or similar public service telephone network plug. The modem includes a data access arrangement (DAA) circuit typically supported by a peripheral component interconnect (PCI) card or similar interface. A DAA circuit includes a line side circuit, a system side circuit and an isolation circuit between them. Initially these circuits were implemented with discrete components; more recently these have been constructed with integrated circuits. Mini-PCI's were introduced to reduce the cost, size and power required. With the rapid decrease in cost of computers, PCIs and mini-PCIs were also under downward price pressure and so more and more of the modem including the DAA circuit, system interface and software are being integrated into the system. This has contributed to the simplification, and reduction in power, size and cost but has introduced a new problem.

In order for a modem to be approved for use in a particular location it must meet the applicable regulatory standards for certification. This is known as homologation. When the modem is assimilated into the motherboard of the host system, the whole system is subject to testing for approval. This can delay the acceptance of the entire system instead of just the target modem.

### SUMMARY OF THE INVENTION

It is therefore an object of this invention to provide such an improved jack module with integrated modem interface circuits.

It is a further object of this invention to provide such an improved jack module with integrated modem interface circuits which decouples the modem from the host system for purpose of independent homologation and certification while maintaining the benefits of having the modem on the system motherboard.

It is a further object of this invention to provide such an improved jack module which permits the modem to be added to the motherboard during or after fabrication or not at all.

It is a further object of this invention to provide such an improved jack module which can incorporate all of the protection circuits.

It is a further object of this invention to provide such an improved jack module which reduces the cost, size, power and space required for the modem.

The invention results from the realization that a truly simple and effective jack module with integrated modem interface circuits can be achieved which decouples the modem from the host system for purposes of independent homologation and certification while maintaining the benefits of having the modem on the system motherboard by disposing the line side circuit in the jack housing and connecting the line side circuit to the jack contacts that engage with the contacts on a plug to be received while providing terminals to allow the jack housing to be easily connected/disconnected from the system motherboard.

This invention features a jack module with integrated modem interface circuits including a jack housing for receiving a plug and a plurality of contacts in the housing for engaging contacts on a plug. There is a plurality of terminals in the housing for interconnecting with the mounting member and a line side circuit in the jack housing and interconnecting with the contacts.

In the preferred embodiment, the jack housing may receive a public service telephone network plug. The jack housing may receive an RJ 11 plug. The terminals may include pins, the pins may be solder pins. There may be an isolation circuit in the housing between the line side circuit and the terminals for isolating the line side circuit from a system side circuit. The system side circuit may be on the mounting member. The mounting member may include a motherboard or an add-in card. The jack housing may include an electrical protection circuit. The electrical protection circuit may include a fuse; the fuse may include a UL 1950 fuse. The jack housing may include a line reversal diode bridge; it may also include compliance circuits. The isolation circuit may include at least one capacitor; it may include at least a transformer. The protection circuit may include a lightning suppression circuit.

### BRIEF DESCRIPTION OF THE DRAWINGS

Other objects, features and advantages will occur to those skilled in the art from the following description of a preferred embodiment and the accompanying drawings, in which:

FIG. 1 is a simplified block diagram of a prior art modem;

FIG. 2 is a simplified block diagram of a jack module with integrated modem interface circuits according to this invention;

FIG. 3 is a three-dimensional schematic view of a jack module with integrated modem interface circuits according to this invention;

FIG. 4 is a top plan view taken along line 4-4 of FIG. 3;

FIG. 5 is a more detailed schematic of one implementation of a line side circuit as shown in FIGS. 1 and 2;

FIG. 6 is a more detailed schematic of one implementation of a system side circuit as shown in FIGS. 1 and 2.

### PREFERRED EMBODIMENT

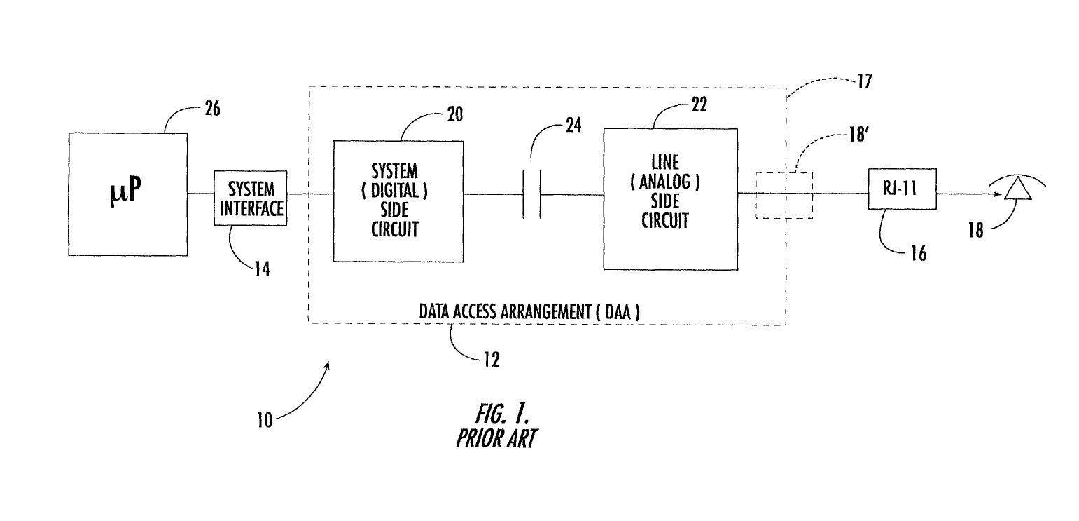

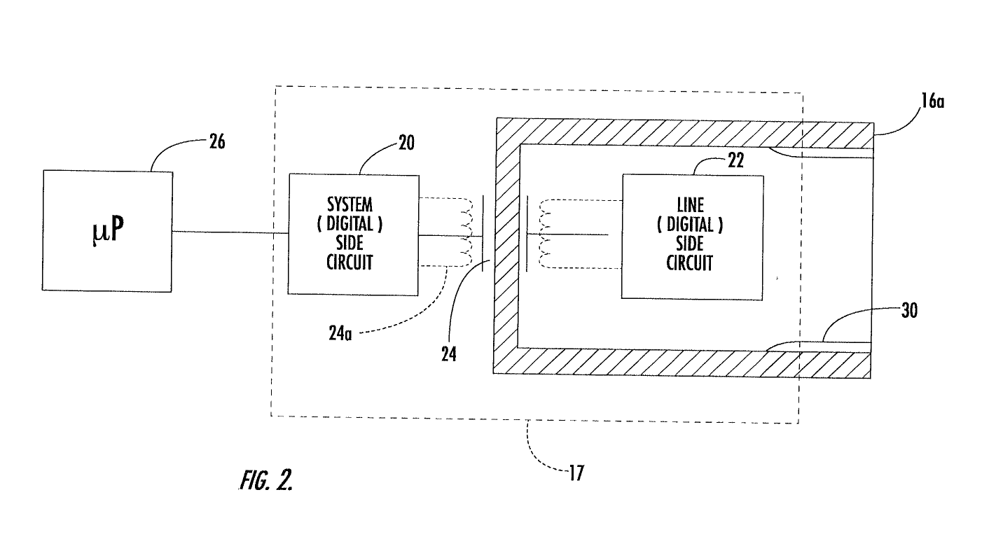

There shown in FIG. 1 a modem 10 including a data access arrangement (DAA) 12 a system interface 14, and a jack 16. Jack 16 is typically an RJ 11 jack and receives a compatible plug from a typical telephone line 18. The RJ 11 or similar jack may be on the end of a cable remote from DAA 12 as shown or it may be combined with and on the same printed circuit board 17 for example as DAA 12 as shown in phantom at 18. Printed circuit board 17 forms the platform for DAA 12 which includes the system side circuit 20, line side circuit 22 and an isolation circuit 24 here indicated as a capacitive coupling. The host may be any desired system typically the computer or microprocessor 26.

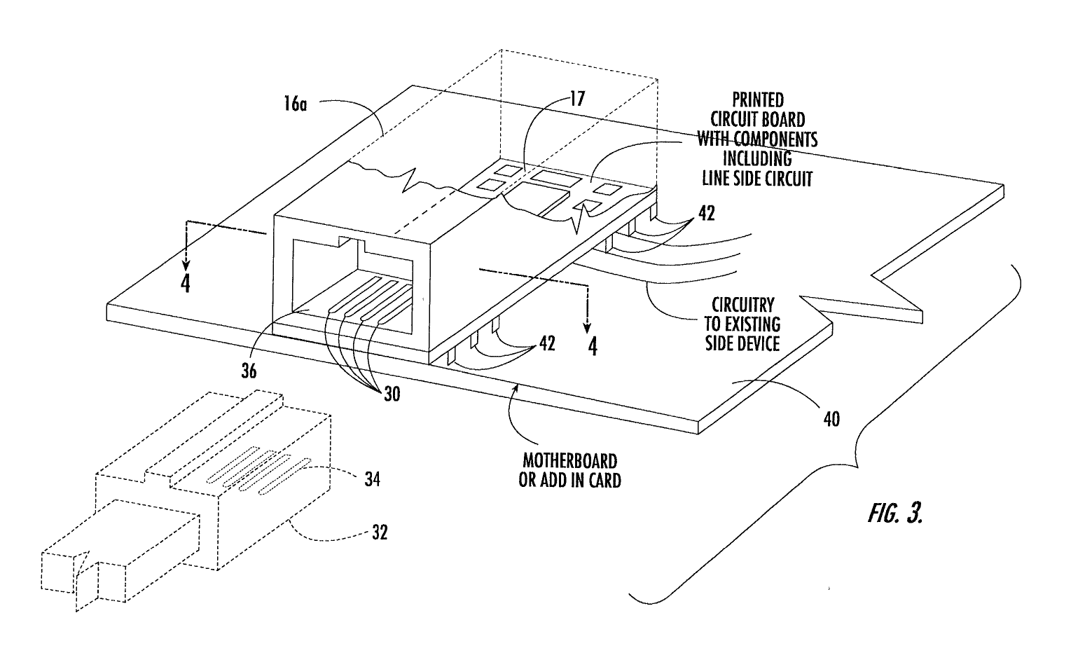

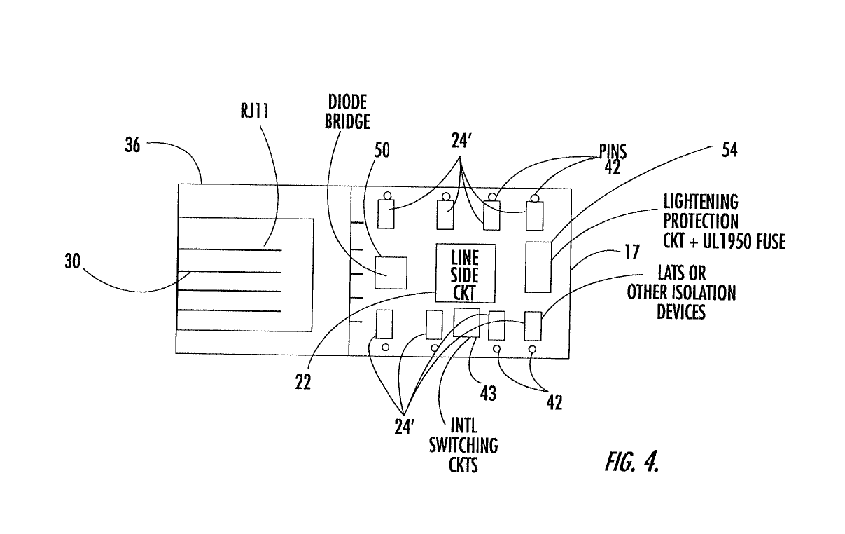

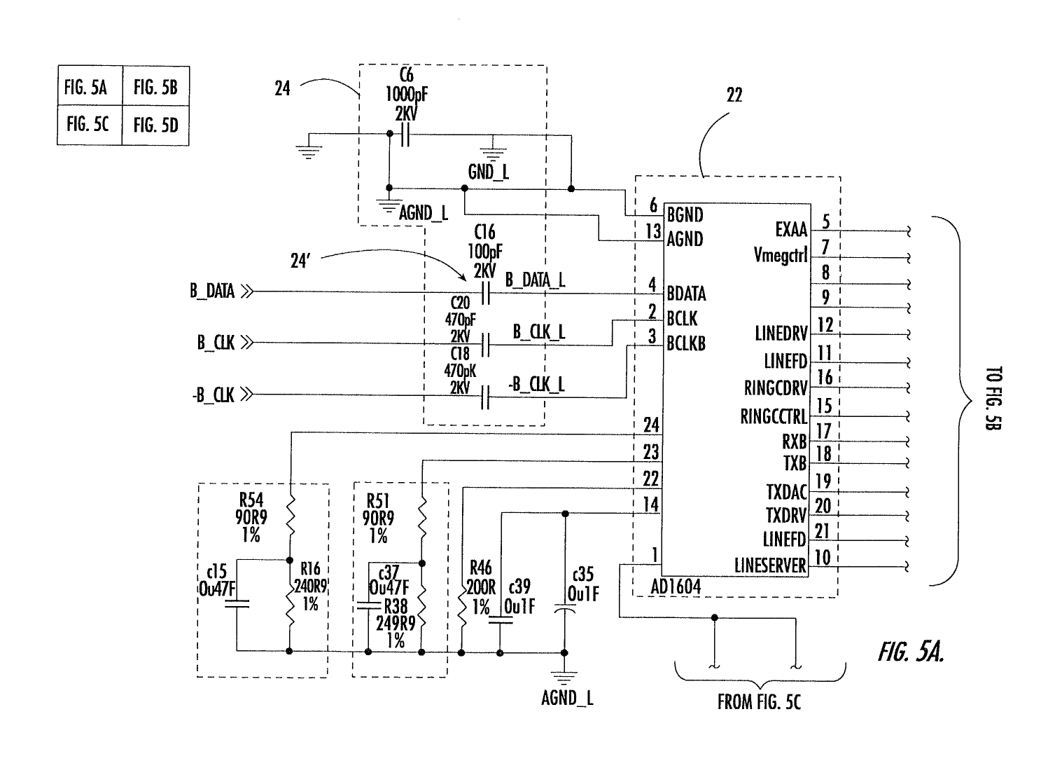

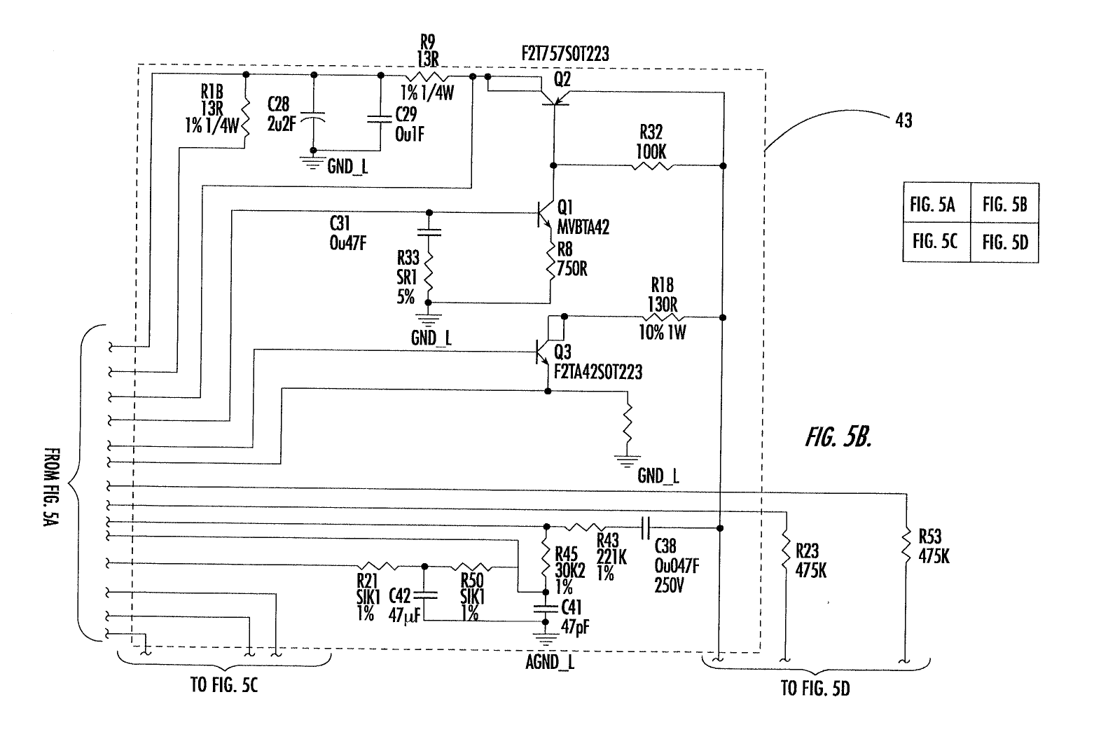

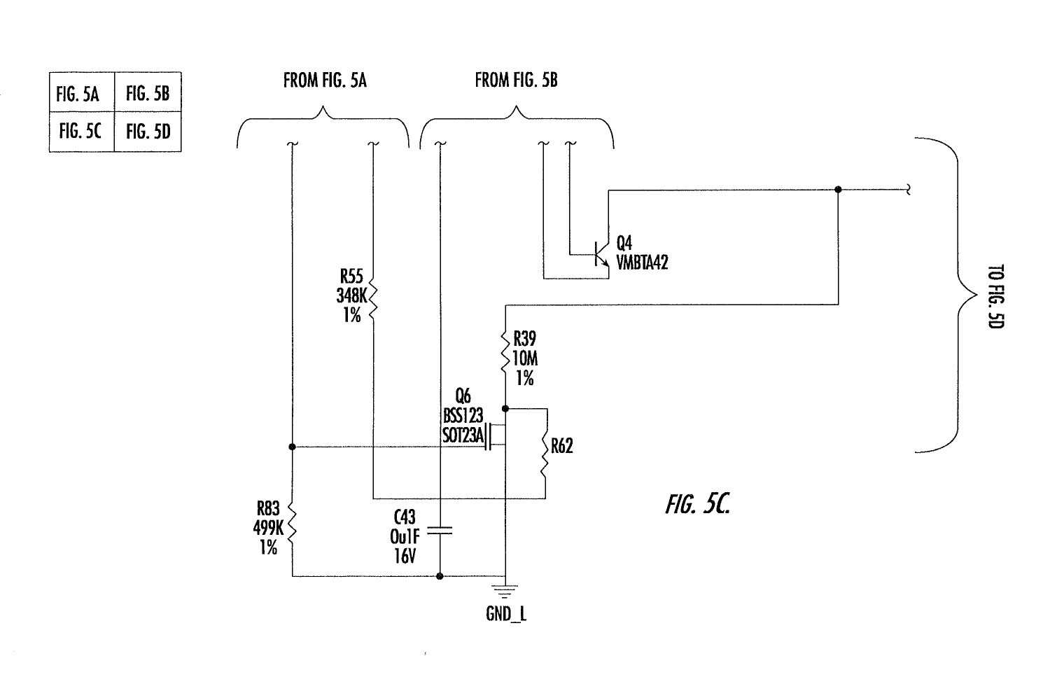

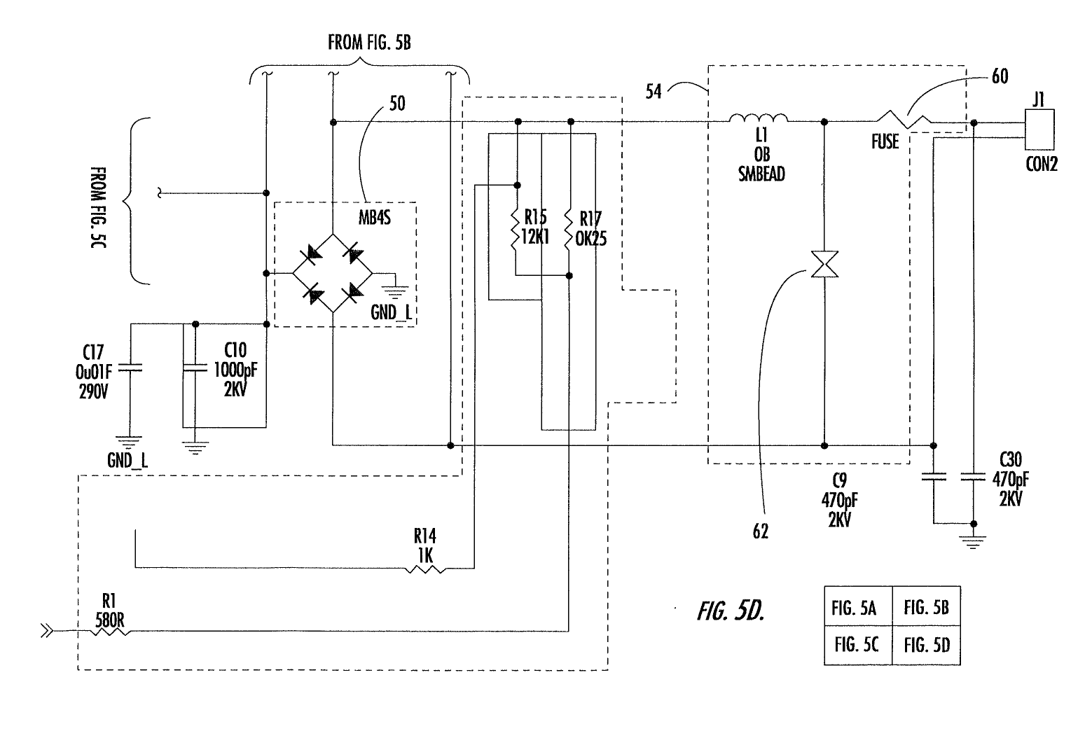

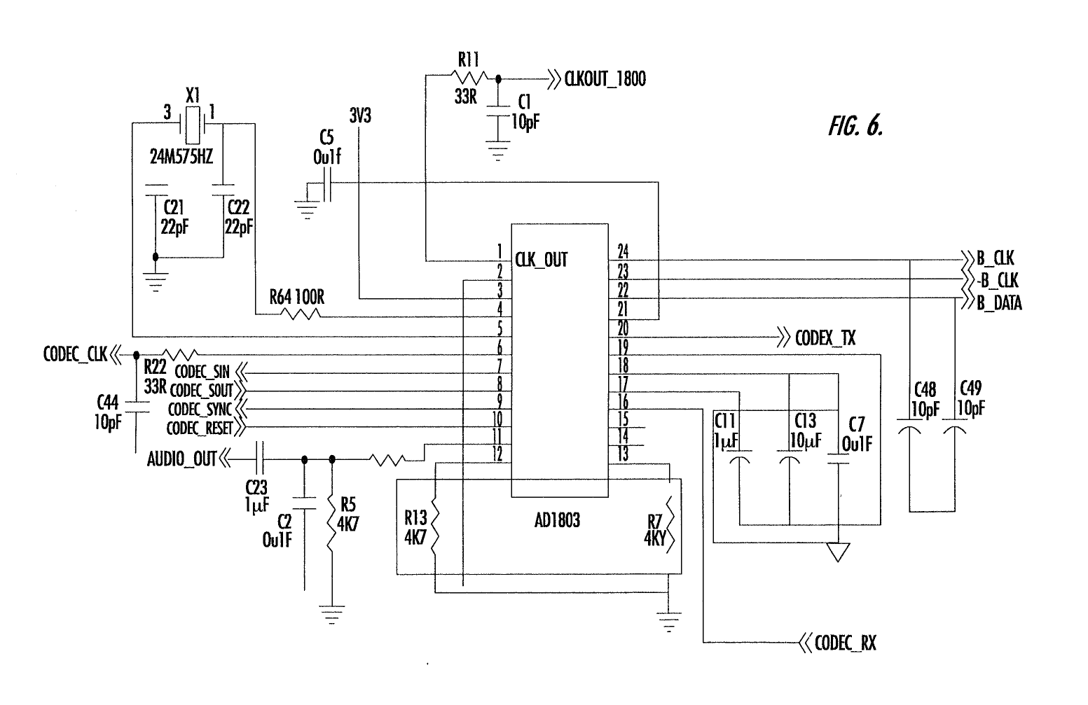

In accordance with this invention a portion of the data access arrangement is included in jack housing 16a which includes contacts 30, FIG. 2, which engage the mating contacts from a compatible plug such as an RJ 11 or other public service telephone network plug. Line side circuit 22 is included within jack housing 16a along with a portion of the isolation circuit 24. As indicated in FIG. 2, the isolation circuit may be capacitive as shown at 24 or inductive as indicated by the presence of transformer 24a shown in phantom or could be optical isolation as well. Jack housing 16a is shown in greater mechanical detail in FIG. 3. Contacts 30 which engage with contacts 32 on RJ 11 plug 34 are disposed on the lower surface 36 of jack housing 16a. In a rearward portion of surface 36 is located printed circuit board 17 which includes line side circuit 22 and may include additionally the isolation circuit and other auxiliary circuits. These may alternatively be on the motherboard or add-in card 40. Jack housing 16a includes terminals 42 which may be threaded screws, solder pins, or any other suitable device which allow it to be easily mounted and often easily dismounted as well to motherboard or add-in card 40. In this way, jack housing 16a with its included modem circuitry is decoupled from the motherboard so that its certification or homologation may be accomplished independent of any effect on the motherboard or its host system. Circuit board 17 is shown in greater detail at FIG. 4 as including not just line side circuit 22 but also the diode bridge 50 to guard against reverse connection of the telephone instrument, a protection circuit 54 which may include a lightning suppression circuit and a fuse as well as other devices. The fuse is typically a UL 1950 fuse. In this particular embodiment the isolation circuit is implemented with capacitors 24′ and in this case they are located right on printed circuit board 17 within jack housing 16a. Although this is not a necessary limitation of the invention they may as well be on the motherboard or on some other printed circuit board or chip. The capacitors 24′ that implement the isolation circuit are connected directly to pins 42, FIG. 4. Printed circuit board 17 also includes compliant circuits 43 which are used to tailor the circuit to the particular standards of the country or region in which it is to be used. FIG. 5 shows one specific implementation of the line side circuit 22 and its associated circuitry including but not limited to the isolation circuit 24, compliant circuit 43, diode bridge 50, and protection circuit 54. Protection circuit 54 includes both UL 1950 fuse 60 and lightning suppression circuitry 62. The device side circuit 20 is shown in greater detail in FIG. 6.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A jack module with integrated modem interface circuits comprising: a jack housing for receiving a plug; a plurality of contacts in said housing for engaging contacts on a plug; a plurality of terminals in said housing interconnecting with a mounting member; and a line side circuit in said jack housing interconnecting with said contacts.

2. The jack module of claim 1 in which said jack housing receives a public services telephone network plug.

3. The jack module of claim 1 in which said jack housing receives an RJ11 plug.

4. The jack module of claim 1 in which said terminals include pins.

5. The jack module of claim 4 in which said terminals include solder pins.

6. The jack module of claim 1 further including an isolation circuit in said housing between said line side circuit and said terminals for isolating said line side circuit from a system side circuit.

7. The jack module of claim 6 in which said system side circuit is on said mounting member.

8. The jack module of claim 1 in which said mounting member includes a motherboard.

9. The jack module of claim 1 in which said mounting member includes an add-in card.

10. The jack module of claim 1 in which said jack housing includes an electrical protection circuit.

11. The jack module of claim 10 in which said electrical protection circuit includes a fuse.

12. The jack module of claim 11 in which said fuse includes a UL 1950 fuse.

13. The jack module of claim 1 in which said jack housing further includes line reversal diode bridge.

14. The jack module of claim 1 in which said jack housing further includes compliance circuits.

15. The jack module of claim 6 in which said isolation circuit includes at least one capacitor.

16. The jack module of claim 6 in which said isolation circuit includes a transformer.

17. The jack module of claim 10 in which said protection circuit includes a lightning suppression circuit.
